(19) United States
(12) Patent Application Publication
(10) Pub. No.: US 2014/0340356 A1
(43) Pub. Date: Nov. 20, 2014

(54) INPUT DEVICE

(71) Applicant: ALPS ELECTRIC CO., LTD., Tokyo (JP)

(72) Inventors: Akihiro Takahashi, Miyagi-Ken (JP); Hiroshi Wakuda, Miyagi-Ken (JP); Shinya Abe, Miyagi-Ken (JP)

(73) Assignee: ALPS ELECTRIC CO., LTD., Tokyo (JP)

(21) Appl. No.: 14/281,113

(22) Filed: May 19, 2014

(30) Foreign Application Priority Data
May 20, 2013 (JP) 2013-106217

(51) Int. Cl. G06F 3/041; G06F 3/044

(52) U.S. Cl. CPC G06F 3/0418; G06F 3/044
USPC 345/174

(57) ABSTRACT

An input device includes a control unit configured to have a first threshold value for a signal intensity, a second threshold value lower than the first threshold value, and a third threshold value for a fluctuation in a coordinate within a predetermined time, wherein the third threshold value has a predetermined range, and in the control unit, in a case where the signal intensity exceeding the first threshold value is obtained or a case where the signal intensity is situated between the first threshold value and the second threshold value and the fluctuation in a coordinate falls within the range of the third threshold value, an operation is recognized as the operation for the operation screen.

### CLAIM OF PRIORITY

This application claims benefit of priority to Japanese Patent Application No. 2013-106217 filed on May 20, 2013, which is hereby incorporated by reference in its entirety.

### BACKGROUND

1. Field of the Disclosure

The present disclosure relates to an electrostatic capacitance-type input device utilizing an algorithm for low signal detection in cases of operating with a glove, and so forth.

2. Description of the Related Art

Japanese Unexamined Patent Application Publication No. 2009-181232 discloses an invention relating to a touch switch that sets a first threshold value for judging the presence or absence of a touch operation and a second threshold value lower than the first threshold value and determines each of two cases to be the touch operation. One of the two cases is a case of exceeding the first threshold value, the other thereof is a case where a characteristic value of a detection value is high and the second threshold value is exceeded while the first threshold value is not exceeded. Here, the characteristic value of the detection value means a touch operation time.

In addition to a case of performing a touch operation with a bare hand, in a case of performing a touch operation with, for example, a glove, a signal intensity output based on a change in electrostatic capacitance becomes smaller than in the case of the bare hand.

Therefore, a case where, in addition to the first threshold value, the second threshold value lower than the first threshold value is set, a signal intensity exceeding the second threshold value while falling below the first threshold value is obtained, and furthermore, the signal intensity is obtained during a predetermined touch operation time is regarded as being in an operation state with wearing a glove or the like.

However, in Japanese Unexamined Patent Application Publication No. 2009-181232, since whether or not the touch operation is judged based only on comparison between the signal intensity and the threshold values, there has been an problem that if a finger unintentionally exists in the vicinity of a touch switch without the intention of an operator and a weak signal intensity between the first threshold value and the second threshold value is obtained during a predetermined time at that time, it is determined to be the same touch operation as an operation state with wearing a glove. In other words, in the algorithm for low signal detection in Japanese Unexamined Patent Application Publication No. 2009-181232, in some case it is difficult to distinguish between an operation with wearing a glove or the like and a case where a finger happens to unintentionally exist in the vicinity of a touch sensor without the intention of an operator, and there has been a possibility that an erroneous input occurs.

### SUMMARY

An input device capable of detecting, based on a change in electrostatic capacitance, an operation in a state of being in contact with or located near an operation screen. The input device includes a control unit configured to have a first threshold value for a signal intensity, a second threshold value lower than the first threshold value, and a third threshold value for a fluctuation in a coordinate within a predetermined time, wherein the third threshold value has a predetermined range, and in the control unit, in a case where the signal intensity exceeding the first threshold value is obtained or a case where the signal intensity is situated between the first threshold value and the second threshold value and the fluctuation in a coordinate falls within the range of the third threshold value, an operation is recognized as the operation for the operation screen.

Not only the signal intensity but also coordinate data is integrated into an algorithm for operation judgment for the operation screen.

In other words, the first threshold value for the signal intensity and the second threshold value lower than the first threshold value are set, and in a case of performing a contact operation on the operation screen with a bare hand, a signal intensity higher than the first threshold value is obtained, and the contact operation may be judged to be an operation for the operation screen.

In addition, in a case where the signal intensity exceeds the second threshold value while falling below the first threshold value, it is judged, using the coordinate data, whether or not an operation for the operation screen.

As for the coordinate data, a fluctuation in a coordinate within a predetermined time is used, and it is judged whether or not the fluctuation in a coordinate falls within the range of the third threshold value.

### BRIEF DESCRIPTION OF THE DRAWINGS

FIG. 1 is a plan view of an embodiment of an input device;

FIG. 2A is a partial longitudinal cross-sectional view illustrating a state of placing a finger in contact with an operation screen of the input device, FIG. 2B is a partial longitudinal cross-sectional view illustrating a state of operating the operation screen of the input device in a state of wearing a glove, and FIG. 2C is a partial longitudinal cross-sectional view illustrating a state of locating the finger near the operation screen of the input device;

FIG. 3 is a block diagram of the input device in the disclosed embodiment;

FIG. 4A illustrates a state where a signal intensity exceeds a first threshold value, FIG. 4B illustrates a state where the signal intensity is situated between the first threshold value and a second threshold value, and FIG. 4C is a conceptual diagram illustrating a relationship between fluctuations in coordinates and a third threshold value;

FIG. 5 is a flowchart diagram for determining the presence or absence of an operation using the input device in the disclosed embodiment; and

FIG. 6 is a conceptual diagram illustrating a relationship between the signal intensity and a time.

### DESCRIPTION OF THE EXEMPLARY EMBODIMENTS

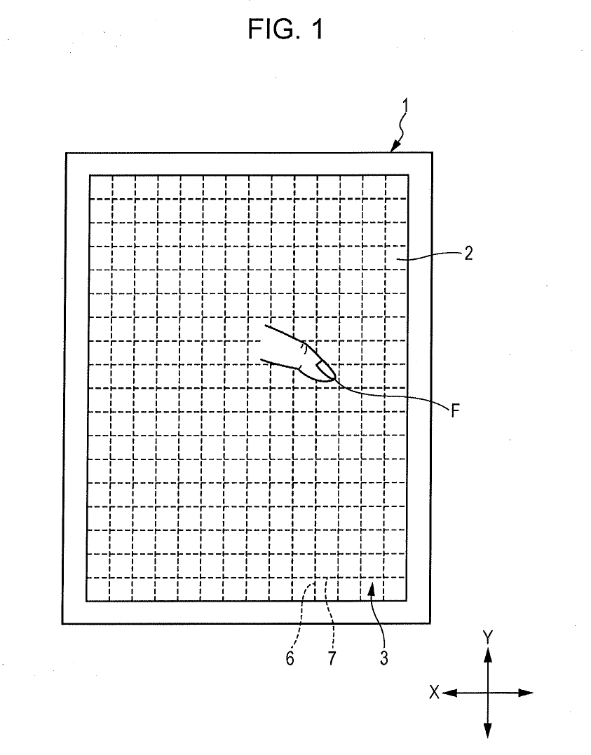

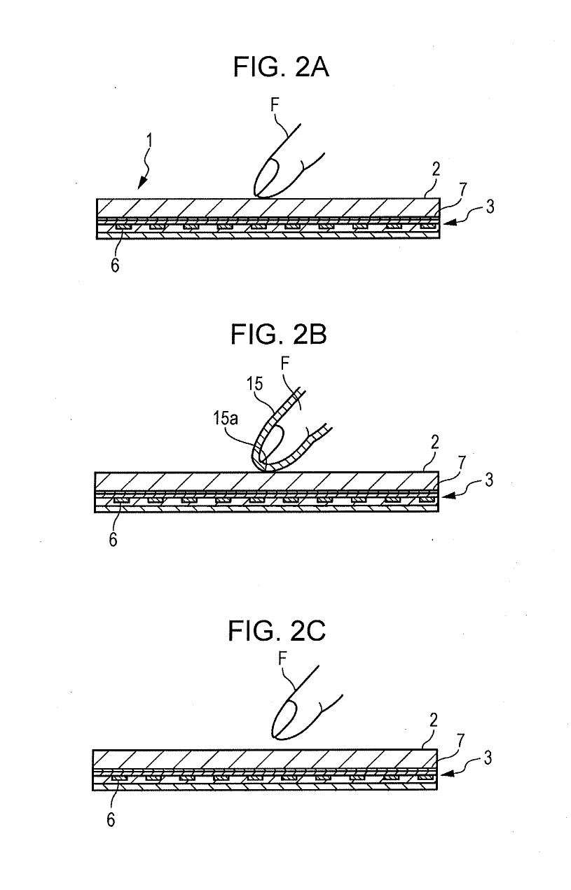

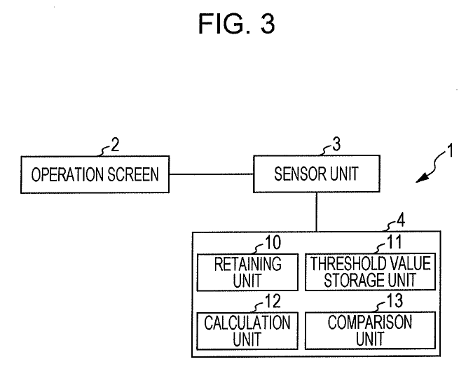

FIG. 1 is a plan view of an embodiment of the input device, FIGS. 2A to 2C are partial longitudinal cross-sectional views of the input device, and FIG. 3 is a block diagram of the input device.

As illustrated in FIG. 1, FIGS. 2A to 2C, and FIG. 3, an input device 1 illustrated in the disclosed embodiment is configured to include, for example, a transparent operation screen 2, a sensor unit (detection unit) 3 located on the back surface side of the operation screen 2, and a control unit 4. In addition, while not being illustrated, a display device such as a liquid crystal display is disposed on the back surface side of the operation screen 2 and the sensor unit 3, and an image corresponding to an operation may be displayed with the operation screen 2 as a display screen.

The operation screen 2 is configured using a transparent resin sheet, glass, plastic, or the like.

The sensor unit 3 is an electrostatic capacitance-type sensor, and a large number of first electrodes 6 and a large number of second electrodes 7 are disposed so as to intersect with each other. The individual electrodes 6 and 7 are formed using indium tin oxide (ITO) or the like. The individual first electrodes 6 are formed in linear arrangements so as to be headed in a Y direction, and disposed at regular intervals in an X direction. In addition, the individual second electrodes 7 are formed in linear arrangements so as to be headed in the X direction, and disposed at regular intervals in the Y direction.

As illustrated in FIG. 1, in performing an operation on the surface of the operation screen 2 using a finger F (operation body), electrostatic capacitance between the finger F and each of the electrodes 6 and 7 changes. Based on this change in electrostatic capacitance, the operation position of the finger F may be detected. As for detection of each operation position, a mutual capacitance detection type where a driving voltage is applied to one electrode of each of the first electrodes 6 and each of the second electrodes 7, a change in electrostatic capacitance with the finger F is detected using the other electrode, and the operation position of the finger F is detected, a self-capacitance detection type where the position coordinates of the finger F are detected based on a change in electrostatic capacitance between the finger F and each of the first electrodes 6 and a change in electrostatic capacitance between the finger F and each of the second electrodes 7, and so forth exist. However, how the position coordinates of the finger F are detected is not a specifically limiting matter.

Each of FIG. 2A, FIG. 2B, and FIG. 2C illustrates an operation state for the operation screen 2.

In FIG. 2A, an operation is performed with the finger F placed in contact with the operation screen 2. In addition, in FIG. 2B, a glove 15 is worn on a hand, and an operation is performed while a leading end 15a of the glove 15 covering the finger F is placed in contact with the operation screen 2. In addition, in FIG. 2C, an operation is performed in a state where the finger F is located near the operation screen 2 (the finger F is not in contact with the operation screen 2).

As illustrated in FIG. 2A, in a case where an operation is performed with the finger F placed in contact with the operation screen 2, a distance between the finger F and the sensor unit 3 is shortened compared with the operation states of FIGS. 2B and 2C. Therefore, a signal intensity obtained by the operation of FIG. 2A becomes larger than signal intensities obtained by the operations of FIGS. 2B and 2C.

As illustrated in FIG. 3, in the control unit 4, a retaining unit 10, a threshold value storage unit 11, a calculation unit 12, and a comparison unit 13 are provided.

In the retaining unit 10, a signal intensity and coordinate data obtained from the sensor unit 3 are retained. In the threshold value storage unit 11, a first threshold value LV1 and a second threshold value LV2 to be compared with the signal intensity are stored. In addition, a third threshold value LV3 to be compared with a fluctuation in a coordinate is stored. Note that the first threshold value LV1 is adjusted to a value larger than the second threshold value LV2.

In addition, in the calculation unit 12, a variance a and so forth are calculated based on the retained coordinate data. In the comparison unit 13, the signal intensity is compared with the first threshold value LV1 and the second threshold value LV2, and the value of a fluctuation in a coordinate is compared with the third threshold value LV3.

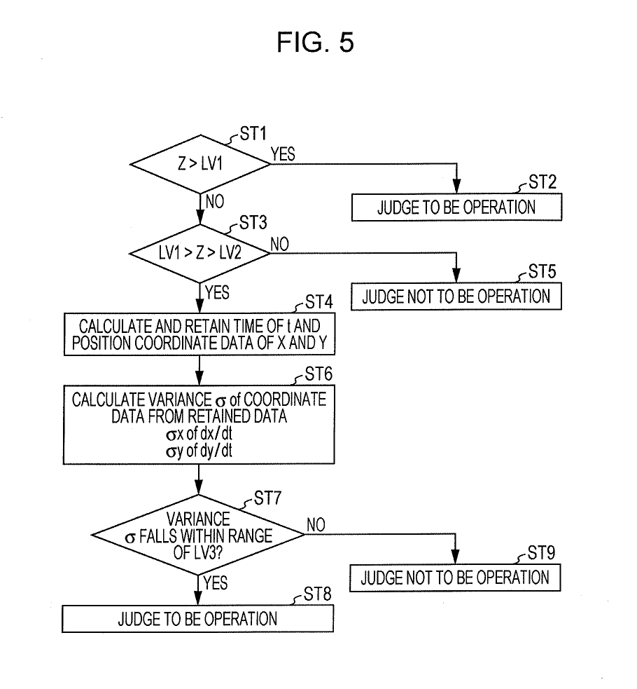

Using a flowchart illustrated in FIG. 5, the judgment of each of the operations in FIGS. 2A, 2B, and 2C is performed.

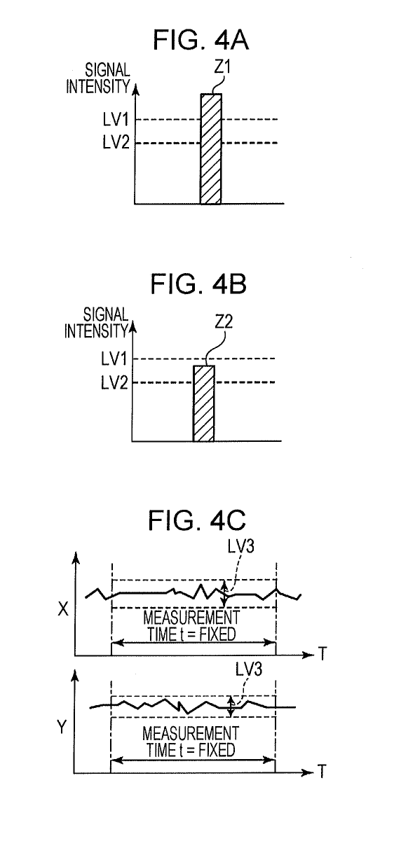

First, in a step ST1 illustrated in FIG. 5, it is determined whether or not an obtained signal intensity Z is larger than the first threshold value LV1. In a case where, as illustrated FIG. 4A, a signal intensity Z1 is larger than the first threshold value LV1, it is judged that an operation has been performed with the finger F placed in contact with the top surface of the operation screen 2 as illustrated in FIG. 2A (step ST2), and the position coordinates (coordinate data) of the finger F is calculated based on a change in electrostatic capacitance, in the calculation unit 12.

Next, in a case of not satisfying the condition of the step ST1, the processing proceeds to a step ST3 illustrated in FIG. 5. In the step ST3, it is determined whether or not the signal intensity Z is situated between the first threshold value LV1 and the second threshold value LV2. In a case where, as illustrated in FIG. 4B, a signal intensity Z2 is situated between the first threshold value LV1 and the second threshold value LV2, the processing proceeds to a step ST4. On the other hand, a case where the signal intensity Z is not situated between the first threshold value LV1 and the second threshold value LV2, in other words, a case where the signal intensity Z falls below the second threshold value LV2 is judged not to be an operation for the operation screen 2 (step ST5).

The signal intensity Z obtained in a case where each of the operations in FIGS. 2B and 2C is performed becomes lower than in a case where an operation is performed with the finger F placed in contact with the operation screen 2, as illustrated in FIG. 2A, and the signal intensity Z is located between the first threshold value LV1 and the second threshold value LV2, as illustrated in FIG. 4B. However, in addition to the case where each of the operations in FIGS. 2B and 2C is performed, the signal intensity Z obtained in a case where an operator brings the finger F close to the operation screen 2 without intention of performing an operation is also situated between the first threshold value LV1 and the second threshold value LV2 in some cases. Accordingly, in and after the step ST4, in a case where the signal intensity Z2 is situated between the first threshold value LV1 and the second threshold value LV2, it is judged whether or not one of the operations of FIGS. 2B and 2C.

In the step ST4 illustrated in FIG. 5, during a predetermined time t, the coordinate data of each of an X coordinate and a Y coordinate is calculated in the calculation unit 12 in the control unit 4, and retained in the retaining unit 10. Subsequently, the processing proceeds to a step ST6, and the variance σ of the coordinate data is calculated in the calculation unit 12.

A case where, as illustrated in FIG. 4C, the variances of the X coordinate and the Y coordinate converge within the predetermined time t (measurement time t) (step ST7) is judged to be the operation for the operation screen 2, illustrated in FIG. 2B or 2C (step ST8).

On the other hand, a case the variances a of the X coordinate and the Y coordinate do not converge within the predetermined time t (measurement time t) is judged not to be an operation for the operation screen 2 (step ST9).

As illustrated in the step ST6 in FIG. 5, the variance σx of the X coordinate may be calculated with dx/dt, and the variance σy of the Y coordinate may be calculated with dy/dt. In addition, in the step ST7, it is determined whether or not these variances σx and σy fall within the range of the third threshold value LV3 illustrated in FIG. 4C.

Alternatively, a fluctuation in a coordinate is not calculated with the variance σ, the fluctuation amount (movement distance) of a coordinate within the predetermined time t is calculated, and it may be determined whether or not the fluctuation amount falls within the range of a third threshold value LV3 (the third threshold value LV3 here is different from the third threshold value at the time of comparing the variance σ).

In a case where the operator unintentionally brings the finger F close to the operation screen 2, the motion of the finger F is unstable, and a fluctuation in a coordinate is out of the range of the third threshold value LV3. Therefore, based on a fluctuation in a coordinate, it may be judged whether or not the operation of FIG. 2B or 2C.

In this way, in the present embodiment, not only the signal intensity but also the coordinate data is integrated into the algorithm for operation judgment for the operation screen.

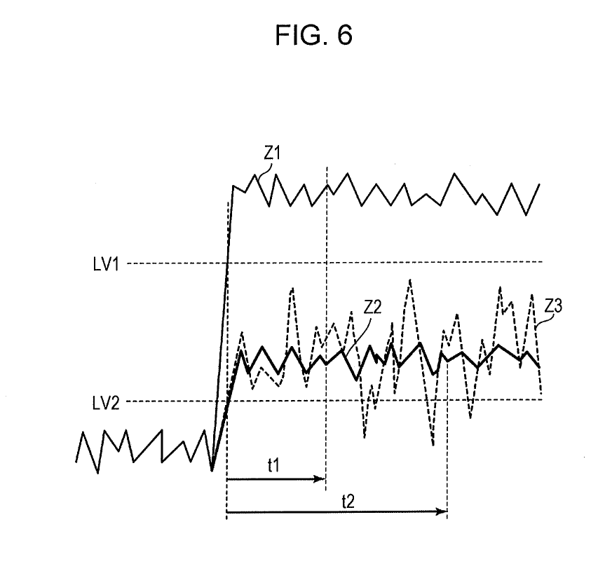

In a case where, as illustrated in, for example, FIG. 6, the signal intensity is measured by means of a time and even a signal intensity Z3, which is obtained between the first threshold value LV1 and the second threshold value LV2 within a short measurement time t1, has a time zone of falling below the second threshold value LV2 within a long measurement time t2, the case may be determined not to be the operation based on FIG. 2B or 2C and to be the motion of a finger not intending to perform an operation. However, more than that is needed. In other words, even if the signal intensity Z2 exists between the first threshold value LV1 and the second threshold value LV2 within the measurement time t2, a state exists where the finger F simply moves closer to the operation screen 2 without intention of performing an operation. Therefore, in the present embodiment, using not only the signal intensity but also the coordinate data, it is judged whether or not an operation for the operation screen 2.

For example, in a case where the operator unintentionally brings the finger F close to the operation screen, or the like, the coordinate data becomes unstable. Therefore, a fluctuation in a coordinate is out of the range of the third threshold value LV3, and the case may be determined not to be an operation for the operation screen 2.

In this way, even in a case where the operator unintentionally brings the finger F close to the operation screen 2, the signal intensity Z exists between the first threshold value LV1 and the second threshold value LV2 in some cases. However, in the present embodiment, the stability of the coordinate data is used as a condition, and hence, a trouble that a case where the operator unintentionally brings the finger F close to the operation screen 2 is recognized as an operation for the operation screen may be suppressed, and an operation with wearing a glove 15 (FIG. 2B) or an operation (hover operation) in a state of locating the finger near the operation screen with an intention (FIG. 2C) may be stably detected.

As described above, in the present embodiment, the algorithm for the low signal detection (the signal intensity exists between the first threshold value and the second threshold value) is improved using the signal intensity and the coordinate data, and hence, the erroneous input of the input device 1 may be suppressed compared with the related art.

Note that, in the step ST1 in FIG. 5, a case where the signal intensity Z1 illustrated in FIG. 4A continuously exceeds the first threshold value LV1 within the measurement time t1 as illustrated in FIG. 6 may be determined to be an operation for the operation screen 2.

In addition, the signal intensity Z2 illustrated in FIG. 4B may be measured during the measurement time t2 as illustrated in FIG. 6, and may be measured only during a time T1 shorter than the measurement time t2. For example, in a case where, within the measurement time t2, a time zone in which the signal intensity is obtained between the first threshold value LV1 and the second threshold value LV2 exists and a time zone in which the signal intensity falls below the second threshold value LV2 also exists, the condition of the step ST3 illustrated in FIG. 5 is not satisfied, and the case may be determined not to be an operation for the operation screen 2.

Note that while, in the present embodiment, the input device 1 capable of detecting the X coordinate and the Y coordinate is adopted, a configuration of being capable of only detecting, for example, one coordinate thereof may be adopted. In that case, using detectable coordinate data, it is determined whether or not an operation for the operation screen 2.

In addition, in a case of the input device 1 capable of detecting the X coordinate and the Y coordinate, at least one of the X coordinate and the Y coordinate may be used only for the coordinate data used for operation judgment for FIG. 2B or 2C. In this regard, however, to utilize the coordinate data of both the X coordinate and the Y coordinate may more effectively and stably detect the operations of FIGS. 2B and 2C, and may be suitable for use.

Note that the individual threshold values LV1, LV2, and LV3 may be variously modified based on a desired input sensitivity, a model equipped therewith, or the like.

The input device 1 in the present embodiment may be incorporated in an electronic device such as a personal computer, a portable device, a game machine, or the like, and in particular, may be effectively applied as a device for a vehicle.

For example, even in a case of driving with wearing driving gloves, an input operation for an input device may be performed.

What is claimed is:

1. An input device for detecting, based on a change in electrostatic capacitance, an operation in a state of being in contact with or located near an operation screen, the input device comprising:
a control unit configured to have a first threshold value for a signal intensity, a second threshold value lower than the first threshold value, and a third threshold value for a fluctuation in a coordinate within a predetermined time, wherein:
the third threshold value has a predetermined range, and
in the control unit, in a case where the signal intensity exceeding the first threshold value is obtained or a case where the signal intensity is situated between the first threshold value and the second threshold value and the fluctuation in a coordinate falls within the range of the third threshold value, an operation is recognized as the operation for the operation screen.

2. The input device according to claim 1, wherein
an X coordinate and a Y coordinate perpendicular within the operation screen are detectable, and
in the control unit, in a case where the signal intensity is between the first threshold value and the second threshold value and the fluctuation in at least one coordinate of the X coordinate and the Y coordinate falls within the range of the third threshold value, an operation is recognized as the operation for the operation screen.
